(19) United States
(12) Patent Application Publication
(10) Pub. No.: US 2024/0416237 A1
(43) Pub. Date: Dec. 19, 2024

(54) COMPUTER-READABLE NON-TRANSITORY STORAGE MEDIUM HAVING GAME PROGRAM STORED THEREIN, GAME PROCESSING SYSTEM, GAME PROCESSING APPARATUS, AND GAME PROCESSING METHOD

(71) Applicant: NINTENDO CO., LTD., Kyoto (JP)

(72) Inventors: Shiro MOURI, Kyoto (JP); Mai YAMAMOTO, Kyoto (JP)

(21) Appl. No.: 18/401,964

(22) Filed: Jan. 2, 2024

(30) Foreign Application Priority Data
Jun. 15, 2023 (JP) 2023-098517

(51) Int. Cl. A63F 13/533; A63F 13/55

(52) U.S. Cl. CPC A63F 13/533; A63F 13/55

(57) ABSTRACT

An item selection UI is displayed in accordance with a predetermined operation during a standby period at the time of starting a game, and progress of a standby period is stopped until selection of an item is finished.

### CROSS REFERENCE TO RELATED APPLICATION

This application claims priority to Japanese Patent Application No. 2023-98517 filed on Jun. 15, 2023, the entire contents of which are incorporated herein by reference.

### FIELD

The present disclosure relates to information processing for a game or the like.

### BACKGROUND AND SUMMARY

Conventionally, there is such a game that a game stage is entered from a course point in a game world and the game stage is cleared, whereby the game progresses.

In such a stage-clear-type game, it is not assumed that a player character is provided with an item in advance to progress in game play. In a case where an item is provided in advance as described above, there might be some labor such as starting a stage again if a player forgets to replace an item, for example.

Accordingly, an object of the exemplary embodiments is to provide a computer-readable non-transitory storage medium having a game program stored therein, a game processing system, a game processing apparatus, and a game processing method that, in a stage-clear-type game, make it possible to provide an item to a player character in advance to progress in game play, and cope with a problem such as forgetting to replace an item without increasing a procedure at the time of starting a stage.

Configuration examples for achieving the above objects will be shown below.

A first configuration example is a non-transitory computer-readable storage medium having stored therein instructions that, when executed by a processor of a game processing apparatus for controlling a player character on the basis of an operation input in a stage set in a virtual space, cause the game processing apparatus to: allow at least one of a plurality of kinds of items to be set on the player character; determine a stage to be played, from among a plurality of the stages; start a first standby period from the determination of the stage to start of the stage; when a predetermined operation input is performed during the first standby period, interrupt the first standby period and present an item selection UI for selecting the item and setting the item on the player character; in a case where the item selection UI is presented, start the first standby period again after selection of the item is finished; after elapse of the first standby period, start game play in the stage; and in game play in the stage, control the player character on the basis of an operation input, while imparting a predetermined effect corresponding to the kind of the set item, to a behavior of the player character or another object in the stage.

According to the above first configuration example, in a stage-clear-type game, it becomes possible to set an item on a player character in advance to progress in game play, and in addition, in such a case where a player forgets to change (replace) an item, the item can be changed before start of a stage, and on the other hand, in a case of not performing change of the item and the like, a stage can be started without increasing extra labor.

In a second configuration example based on the first configuration example, the instructions further cause the game processing apparatus to: in a case where the player character satisfies a predetermined condition as a mistake in the stage, end play and start a second standby period until restart of play; when a predetermined operation input is performed during the second standby period, interrupt the second standby period and present an item selection UI for selecting the item and setting the item on the player character; in a case where the item selection UI is presented, start the second standby period again after selection of the item is finished; and after elapse of the second standby period, restart play from a predetermined position in the stage.

According to the above second configuration example, in a case of trying to play again after making a mistake, if a player desires to replace an item, the player can change the item and play again, and on the other hand, if a player does not replace an item, the player can play again without increase in the waiting time.

In a third configuration example based on the first configuration example, the instructions further cause the game processing apparatus to: in a case where the player character satisfies a predetermined condition as a mistake in the stage, end play and start a second standby period until restart of play; present an item selection UI for selecting the item and setting the item on the player character; when a predetermined operation input for selecting the item is performed during the second standby period, interrupt the second standby period, and after selection of the item is finished, start the second standby period again; and after elapse of the second standby period, restart play from a predetermined position in the stage.

According to the above third configuration example, in a case of trying to play again after making a mistake, a player can be prevented from forgetting to perform item replacement or the like, and play can be prevented from starting again during an operation for item replacement or the like.

In a fourth configuration example based on the first configuration example, the instructions further cause the game processing apparatus to: in a case where the player character has satisfied a predetermined condition as a mistake in the stage, end play and present an item selection UI for selecting the item and setting the item on the player character; after selection of the item is finished, start a second standby period until restart of play; when a predetermined operation input is performed during the second standby period, interrupt the second standby period and present the item selection UI, and after selection of the item is finished, start the second standby period again; and after elapse of the second standby period, restart play from a predetermined position in the stage.

According to the above fourth configuration example, in a case of trying to play again after making a mistake, a player can be prevented from forgetting to perform item replacement or the like and thereafter the player can perform item replacement again, and on the other hand, if a player does not replace an item, the player can play again without increase in the waiting time until the play is started again.

In a fifth configuration example based on the first configuration example, the instructions cause the game processing apparatus to, in a scene before the stage to be played is determined, present the item selection UI on the basis of an operation input, to allow selection of the item to be set.

According to the above fifth configuration example, an item to be set can be determined as necessary before a stage to be played is determined.

In a sixth configuration example based on the first configuration example, the instructions cause the game processing apparatus to, in game play in the stage, control the player character without allowing change of the item set on the player character.

According to the above sixth configuration example, the difficulty level of game play can be maintained appropriately.

In a seventh configuration example based on the first configuration example, the instructions cause the game processing apparatus to, in a case where the item selection UI is presented during the first standby period, start the first standby period again with a remaining time thereof prolonged by a predetermined period, after selection of the item is finished.

According to the above seventh configuration example, a time for performing item change or the like again can be ensured.

In an eighth configuration example based on the first configuration example, the instructions cause the game processing apparatus to load data regarding the stage during the first standby period.

According to the above eighth configuration example, a period in which data is loaded can be made less conspicuous.

According to the exemplary embodiments, it becomes possible to provide a computer-readable non-transitory storage medium having a game program stored therein, a game processing system, a game processing apparatus, and a game processing method that, in a stage-clear-type game, make it possible to provide an item to a player character in advance to progress in game play, and cope with a problem such as forgetting to replace an item without increasing a procedure at the time of starting a stage.

### BRIEF DESCRIPTION OF THE DRAWINGS

FIG. 1 shows a non-limiting example of a state in which a left controller 3 and a right controller 4 are attached to a main body apparatus 2;

FIG. 2 is a block diagram showing a non-limiting example of the internal configuration of the main body apparatus 2;

FIG. 3 is a block diagram showing a non-limiting example of the internal configurations of the main body apparatus 2, the left controller 3, and the right controller 4;

FIG. 4 illustrates a non-limiting example of screens in stage selection;

FIG. 5 illustrates a non-limiting example of screens in starting a game;

FIG. 6 illustrates a non-limiting example of screens in restarting a game;

FIG. 7 illustrates a non-limiting example of screens in restarting a game;

FIG. 8 shows a non-limiting example of various data stored in a DRAM 85;

FIG. 9 shows a non-limiting example of a flowchart of game processing;

FIG. 10 shows a non-limiting example of a flowchart of game processing;

FIG. 11 shows a non-limiting example of a flowchart of game processing;

FIG. 12 shows a non-limiting example of a flowchart of game processing; and

FIG. 13 shows a non-limiting example of a flowchart of game processing.

### DETAILED DESCRIPTION OF NON-LIMITING EXAMPLE EMBODIMENTS

Hereinafter, an exemplary embodiment will be described.

### Hardware Configuration of Information Processing System

Hereinafter, an information processing system (game system/game apparatus) according to an example of the exemplary embodiment will be described below. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies. Hereinafter, first, the hardware configuration of the game system 1 according to the exemplary embodiment will be described, and then, the control of the game system 1 according to the exemplary embodiment will be described.

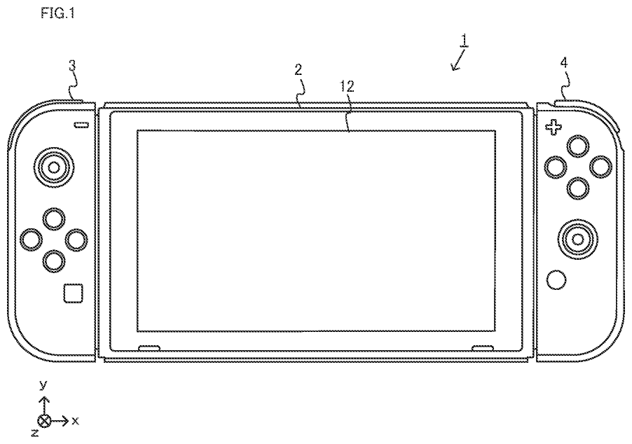

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes in the game system 1. The main body apparatus 2 includes a display 12. Each of the left controller 3 and the right controller 4 is an apparatus including operation sections with which a user provides inputs.

The main body apparatus 2 also includes speakers 88, and sounds such as sound effects are outputted from the speakers 88.

The main body apparatus 2 also includes a left terminal 17 for the main body apparatus 2 to perform wired communication with the left controller 3, and a right terminal 21 for the main body apparatus 2 to perform wired communication with the right controller 4.

The main body apparatus 2 also includes a slot 23. The slot 23 is provided on an upper side surface of a housing of the main body apparatus 2. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2.

Each of the left controller 3 and the right controller 4 includes various operation buttons, etc. The various operation buttons, etc., are used to give instructions according to various programs (e.g., an OS program and an application program) executed by the main body apparatus 2.

Each of the left controller 3 and the right controller 4 also includes a terminal 42 or 64 for performing wired communication with the main body apparatus 2.

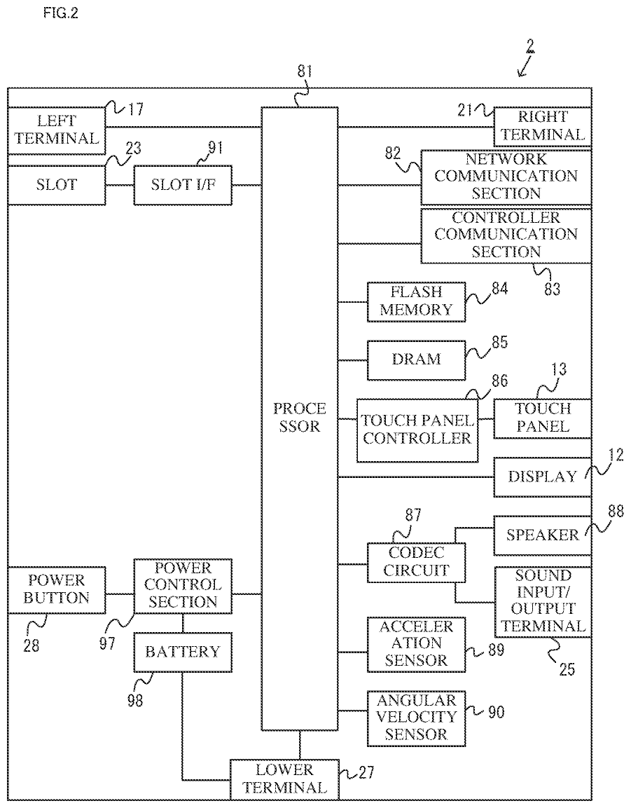

FIG. 2 is a block diagram showing an example of the internal configuration of the main body apparatus 2. The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, the network communication section 82 connects to a wireless LAN by a method compliant with the Wi-Fi standard, for example, and performs Internet communication or the like with an external apparatus (another main body apparatus 2). Further, the network communication section 82 can also perform short-range wireless communication (e.g., infrared light communication) with another main body apparatus 2.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the above left terminal 17, the above right terminal 21, and a lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with a cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2, or the main body apparatus 2 alone, is attached to the cradle, the main body apparatus 2 can output data (e.g., image data or sound data) to the stationary monitor or the like via the cradle.

The main body apparatus 2 includes a touch panel controller 86, which is a circuit for controlling a touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and the speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

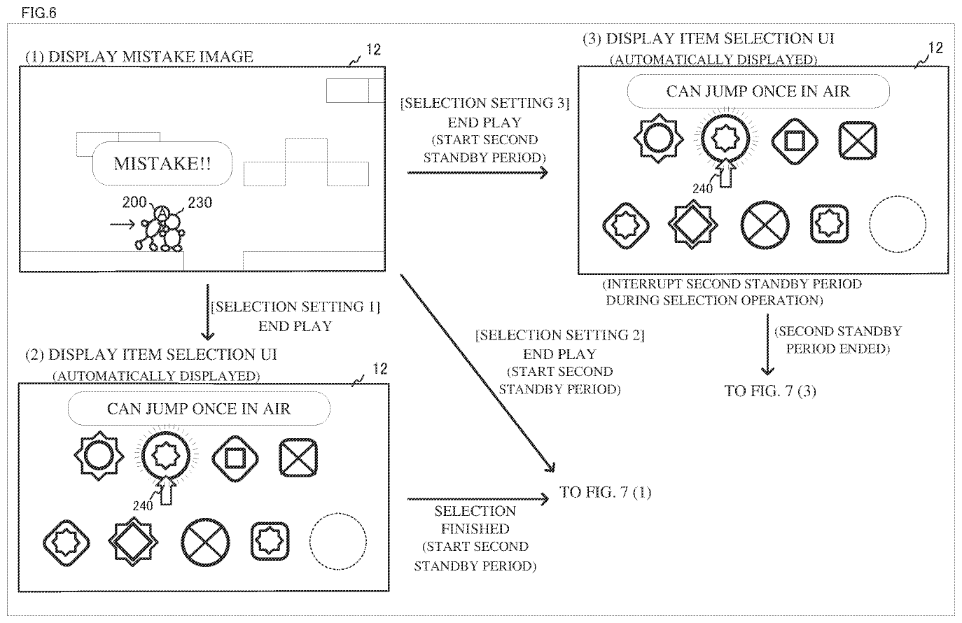

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

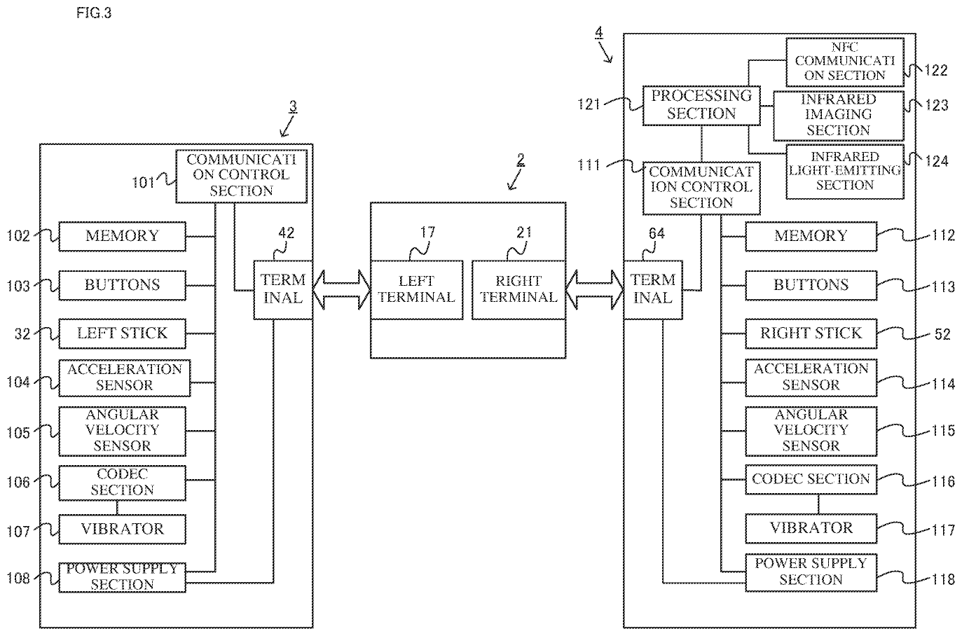

FIG. 3 is a block diagram showing examples of the internal configurations of the main body apparatus 2, the left controller 3, and the right controller 4. It should be noted that the details of the internal configuration of the main body apparatus 2 are shown in FIG. 2 and therefore are omitted in FIG. 3.

The left controller 3 includes a communication control section 101, which communicates with the main body apparatus 2. As shown in FIG. 3, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

The left controller 3 also includes a memory 102 such as a flash memory. The communication control section 101 includes, for example, a microcomputer (or a microprocessor) and executes firmware stored in the memory 102, thereby performing various processes.

The left controller 3 includes buttons 103. The left controller 3 also includes a left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., xyz axes shown in FIG. 1) directions. It should be noted that the acceleration sensor 104 may detect an acceleration along one axial direction or accelerations along two axial directions. In the exemplary embodiment, the angular velocity sensor 105 detects angular velocities about predetermined three axes (e.g., the xyz axes shown in FIG. 1). It should be noted that the angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation, or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a power supply section 108. In the exemplary embodiment, the power supply section 108 includes a battery and a power control circuit. Although not shown, the power control circuit is connected to the battery and also connected to components of the left controller 3 (specifically, components that receive power supplied from the battery).

As shown in FIG. 3, the right controller 4 includes a communication control section 111, which communicates with the main body apparatus 2. The right controller 4 also includes a memory 112 which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, a right stick 52, and inertial sensors (an acceleration sensor 114 and an angular velocity sensor 115). These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### Game Assumed in Exemplary Embodiment

Next, the outline of game processing (example of information processing) executed in the game system 1 according to the exemplary embodiment will be described. The game assumed in the exemplary embodiment is, for example, an action game in which, in a virtual space (game space) where various objects are placed, a player object (which may be referred to as “player character”) which acts in accordance with an operation by a player (user) performs movement and the like to achieve a predetermined purpose. Specifically, in this action game, from a plurality of game stages (which may be simply referred to as “stage”), a player selects a stage to play, and plays in the selected stage, to clear a plurality of stages. The game is not limited to an action game and may be another kind of game (e.g., role-playing game or sport game).

### Outline of Game Processing in Exemplary Embodiment

In this game processing, a plurality of game apparatuses 1 are connected communicably with each other via the Internet or through short-range wireless communication, etc., to perform a multi-play game. In this game processing, it is also possible to perform a single-play game by one game apparatus 1.

In this game processing, an action of a character placed in a virtual space, and the like, are controlled in accordance with an operation by a player, and an image of the virtual space is taken (drawn) by a virtual camera and displayed on a screen (display 12), while the game progresses. In this game processing, the player selects a desired stage from a plurality of stages and performs game play in the selected stage.

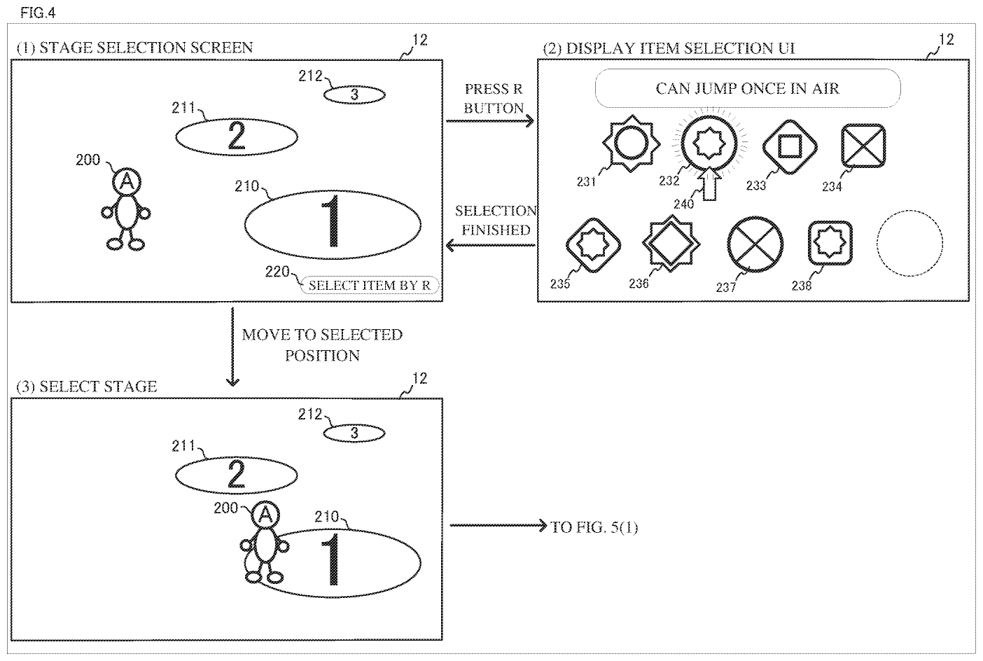

FIG. 4 illustrates a case where the player selects (sets) an item in a scene of selecting a stage to play. As shown in FIG. 4(1), in a virtual space (which may be referred to as “stage selection space”) for the player to select a stage to play, a player character 200 which moves on the ground in accordance with a player's operation and circular areas (which may be referred to as “stage selection areas”) 210 to 212 for selecting a stage, are arranged, and an image of the stage selection space is taken (drawn) by the virtual camera from an obliquely upper side, whereby a stage selection screen is displayed on the game apparatus 1. As shown in FIG. 4(1), on the stage selection screen, a text indication 220, “select item by R”, is displayed in a comparatively small size. This indicates that it is possible to shift to a scene for selecting (determining) an item to be used by the player character 200, by pressing an R button which is a specific button of the right controller 4.

When the R button is pressed in a state in which the stage selection screen is displayed (scene for selecting a stage), as shown in FIG. 4(2), an item selection UI (user interface) is displayed (presented). As shown in FIG. 4(2), on the item selection UI, a plurality of items 231 to 238 that have already been acquired and a cursor 240 are displayed. In the example in FIG. 4(2), one space (frame) for displaying an acquired item is left on a side of the item 238, as shown by a broken line. Each of the plurality of items 231 to 238, when selected, exerts (imparts) a specific effect to the player character or another object, etc., in a stage. For example, the item 232 exerts an effect of enabling the player character to jump once in the air, the item 233 exerts an effect that the player character is less damaged, the item 234 exerts an effect of allowing the player character to pass through a block or a wall, the item 235 exerts an effect that a special item appears in a stage, and the item 236 exerts an effect that the player character is less likely to be attacked by an enemy character. On the item selection UI, the items 231 to 238 may be designed so as to suggest their respective effects. As described above, the items are for exerting (imparting) predetermined effects to the behavior of the player character, another object, and the like.

The player can select one of the plurality of items 231 to 238 for the player character 200. Specifically, the player can cancel selection of an already selected item and select another item (i.e., replace the item), and also can newly select an item in a state in which no item is selected. The player can move the cursor 240 to the position of a desired item by operating the right stick 52, and then can temporarily select the item by pressing an A button. In this case, if there is another item that has already been selected, the selection of the item is canceled. As shown in FIG. 4(2), the item 232 is temporarily selected, and the item 232 emits light to indicate the selected state. In addition, a text explaining the effect of the item where the cursor 240 is located is displayed at an upper part of the screen. In FIG. 4(2), a text explaining the effect of the item 232, “can jump once in the air”, is displayed at an upper part of the screen. Then, by pressing the R button in a state in which the item is temporarily selected, the selection of the item can be finished (i.e., the item is finally determined). When the selection of the item is finished, the screen returns to the stage selection screen shown in FIG. 4(1).

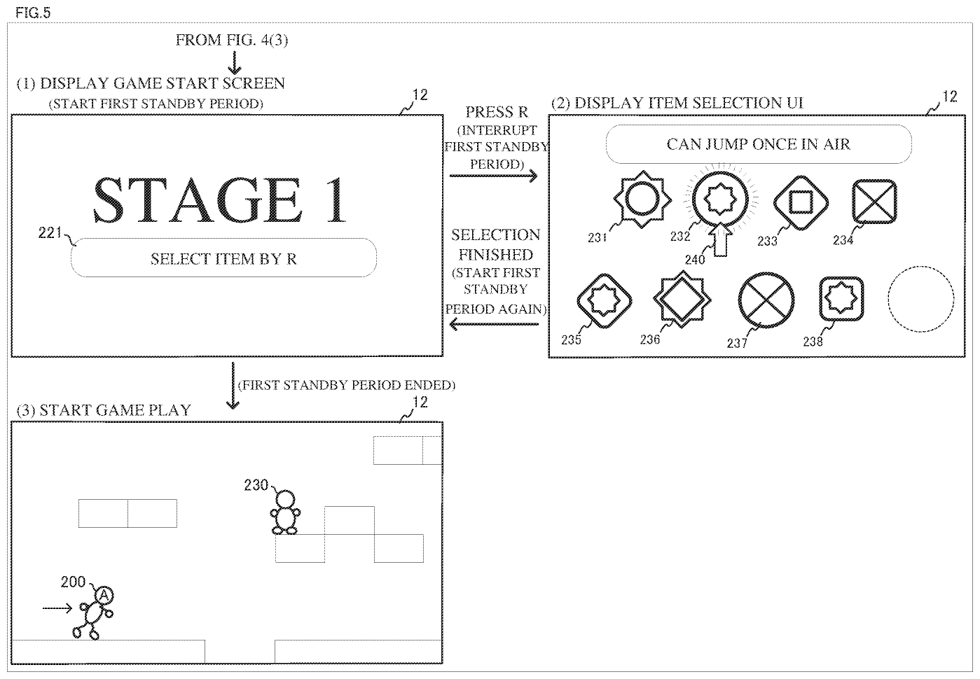

Then, as shown in FIG. 4(3), the player moves the player character 200 onto a desired stage selection area, and thereby can start a game in the stage corresponding to the stage selection area. In FIG. 4(3), the player character 200 moves onto the stage selection area 210, so that the screen shifts to a scene in FIG. 5(1) and thus a stage 1 associated with the stage selection area 210 is to be started.

As described above, in a state in which the stage selection screen is displayed (scene for selecting a stage), the player can perform an operation such as replacing an item, by pressing the R button to display the item selection UI and then selecting an item.

FIG. 5 illustrates a case where an item is selected (set) in a scene in which the player starts a game in a stage. When a stage is selected (determined) on the stage selection screen (see FIG. 4(3)), as shown in FIG. 5(1), a game start screen for the selected stage is displayed, and at the same time, a standby period (a first standby period provided in starting the game; initially set at four seconds) is started. This standby period is the same as a period in which the game start screen is displayed, and data for executing the stage is loaded during the standby period. As shown in FIG. 5(1), on the game start screen, the name of the stage to be started is displayed and a text indication 221, “select item by R”, is displayed in a comparatively large size. This indicates that it is possible to select an item to be used by the player character 200, by pressing the R button, as with the text indication 220 in FIG. 4(1).

Then, when the R button is pressed in a state in which the game start screen is displayed (i.e., during the first standby period), as shown in FIG. 5(2), an item selection UI similar to that in FIG. 4(2) is displayed (presented), and at the same time, the first standby period is interrupted (time decrement calculation is interrupted). The details in selecting an item on the item selection UI are the same as those described with reference to FIG. 4(2). Then, when selection of an item is finished on the item selection UI, the screen returns to the game start screen shown in FIG. 5(1), and at the same time, the first standby period is started again (time decrement calculation is started again). Here, at the time when the first standby period is started again, the remaining time of the first standby period is prolonged by 1.5 seconds. Thus, for example, even in a case where the remaining time of the first standby period is short, the first standby period is prolonged by 1.5 seconds, so that the player can display the item selection UI again and select an item again. At a timing when selection of an item is finished and the screen returns to the game start screen, the remaining time of the first standby period may be set to be 1.5 seconds, instead of prolonging the first standby period by 1.5 seconds.

Then, as shown in FIG. 5(3), when the first standby period has ended, game play in the stage 1 is started. As shown in FIG. 5(3), the stage in this game is a virtual space where the player character moves two-dimensionally, and if the player character 200 contacts with the enemy character 230 or falls into a hole, this is treated as a mistake and the number of remaining player characters 200 are decreased by one. If there is one or more player characters 200 remaining, play is started again from the mistake position, whereas if the number of remaining player characters 200 is zero, the stage has failed to be cleared and the stage is ended. The game stage may be a three-dimensional space. During game play in the stage, the item selection UI cannot be displayed and selection (replacement or the like) of an item cannot be performed.

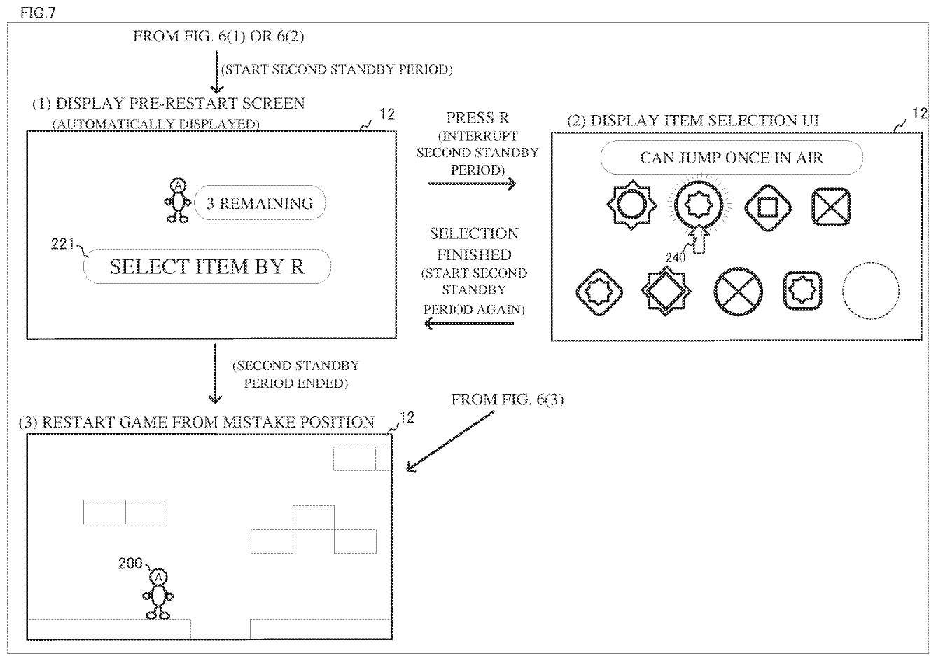

FIG. 6 and FIG. 7 illustrate a case where an item is selected (set) in a scene in which a mistake occurs in the stage and the game is restarted. In this game, by performing a predetermined operation, the player can make a setting (select one of selection settings 1 to 3) regarding control for item selection in a scene of restarting a game. This will be specifically described below.

First, when a mistake has occurred as shown in FIG. 6(1), in a case of the selection setting 1, the play is once finished and an item selection UI is automatically displayed as shown in FIG. 6(2). Then, the player can select an item (perform replacement or the like) on the item selection UI displayed automatically. The details in selecting an item on the item selection UI shown in FIG. 6(2) are the same as those described with reference to FIG. 4(2).

Then, when selection of an item is finished on the item selection UI, as shown in FIG. 7(1), a pre-restart screen is automatically displayed and at the same time, a standby period (a second standby period provided in restarting a game; initially set at three seconds) is started. As shown in FIG. 7(1), on the pre-restart screen, an indication showing the number of remaining player characters is displayed and a text indication 221, “select item by R”, is displayed in a comparatively large size. This indicates that it is possible to select an item to be used by the player character 200, by pressing the R button, as with the text indication 220 in FIG. 4(1).

Then, when the R button is pressed in a state in which the pre-restart screen is displayed (i.e., during the second standby period), as shown in FIG. 7(2), an item selection UI similar to that in FIG. 4(2) is displayed, and at the same time, the second standby period is interrupted (time decrement calculation is interrupted). The details in selecting an item on the item selection UI are the same as those described with reference to FIG. 4(2). Then, when selection of an item is finished on the item selection UI, the screen returns to the pre-restart screen shown in FIG. 7(1), and at the same time, the second standby period is started again (time decrement calculation is started again). Here, at the time when the second standby period is started again, the remaining time of the second standby period is prolonged by 1.5 seconds. Thus, for example, even in a case where the remaining time of the second standby period is short, the second standby period is prolonged by 1.5 seconds, so that the player can display the item selection UI again and select an item again. At a timing when selection of an item is finished and the screen returns to the pre-restart screen, the remaining time of the second standby period may be set to be 1.5 seconds, instead of prolonging the second standby period by 1.5 seconds.

Then, at the same time as the second standby period has ended, display of the pre-restart screen is ended and game play is restarted from the mistake position, as shown in FIG. 7(3).

Next, a case of the selection setting 2 will be described. In this case, when a mistake has occurred as shown in FIG. 6(1), the pre-restart screen is automatically displayed as shown in FIG. 7(1), and at the same time, a standby period (a second standby period provided in restarting a game; initially set at three seconds) is started. Then, the same control as in the selection setting 1 described above with reference to FIG. 7 is performed. That is, the selection setting 2 is a setting obtained by eliminating the operation of automatically displaying the item selection UI in the selection setting 1 (see FIG. 6(2)).

Next, a case of the selection setting 3 will be described. In this case, when a mistake has occurred as shown in FIG. 6(1), an item selection UI is automatically displayed as shown in FIG. 6(3), and at the same time, a standby period (a second standby period provided in restarting a game; initially set at three seconds) is started. The second standby period is interrupted (time decrement calculation is interrupted) during a period in which an operation for selecting an item on the item selection UI. For example, the second standby period is interrupted during a period from when an operation of moving the cursor 240 as described with reference to FIG. 4(2) is performed to when selection of an item is finally determined. At the time when the operation of selecting an item on the item selection UI is finished and the second standby period is started again, the remaining time of the second standby period may be prolonged by 1.5 seconds or the remaining time of the second standby period may be set to be 1.5 seconds. Then, at the same time as the second standby period has ended, display of the item selection UI is ended, and as shown in FIG. 7(3), game play is restarted from the mistake position.

### Details of Information Processing in Exemplary Embodiment

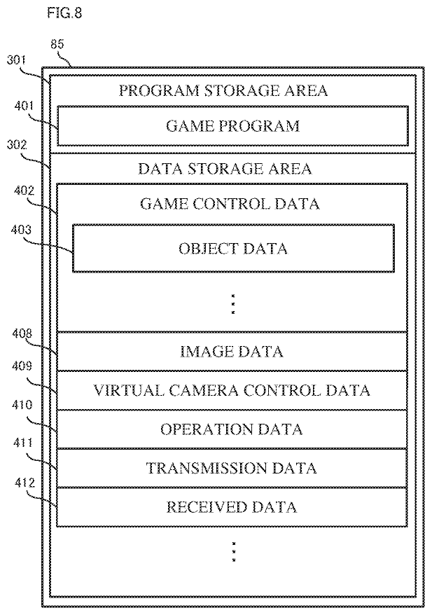

Next, with reference to FIG. 8 to FIG. 13, the information processing in the exemplary embodiment will be described in detail.

### Used Data

Various data used in this game processing will be described. FIG. 8 shows an example of data stored in the DRAM 85 of the game system 1. As shown in FIG. 8, the DRAM 85 has at least a program storage area 301 and a data storage area 302. A game program 401 is stored in the program storage area 301. In the data storage area 302, game control data 402, image data 408, virtual camera control data 409, operation data 410, transmission data 411, received data 412, and the like, are stored. The game control data 402 includes object data 403.

The game program 401 is a game program for executing this game processing.

The object data 403 is data of objects to be placed in a virtual space, and is data of objects such as the own player character, enemy characters, items, grounds, blocks, rocks, stones, trees, and constructions. The object data 403 further includes data of the coordinates (positions), directions, postures, states, and the like of objects.

The image data 408 is image data of backgrounds, virtual effects, and the like.

The virtual camera control data 409 is data for controlling movement of a virtual camera placed in a virtual space. Specifically, the virtual camera control data 409 is data for specifying the position, the orientation, the angle of view, the shooting direction, and the like of the virtual camera.

The operation data 410 is data indicating the contents of operations performed on the left controller 3 and the right controller 4. For example, the operation data 410 includes data indicating input states regarding movements and orientation changes of the left controller 3 and the right controller 4, press states of the buttons thereof, and the like. The contents of the operation data 410 are updated at a predetermined cycle on the basis of signals from the left controller 3 and the right controller 4.

The transmission data 411 is data to be transmitted to another game system 1, and includes at least information for identifying the transmission source and the contents of the operation data 410. The transmission data 411 includes data (data indicating coordinates (position), posture, state, etc.) about the own player character, and the like, to be transmitted to another game system 1 of another player in multi-play.

The received data 412 is data that is the transmission data received from another game system 1 and is stored in an identifiable manner for each of other game systems 1 (i.e., for each transmission source). The received data 412 includes data (data indicating coordinates (position), posture, state, etc.) about another player character, received from another game system 1 of another player in multi-play (or from a server).

In addition to the above, various data to be used in the game processing are stored in the DRAM 85, as necessary.

### Details of Game Processing

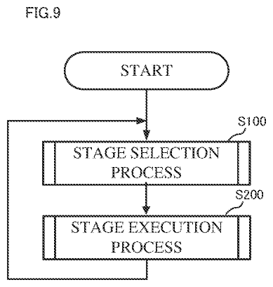

Next, with reference to flowcharts, the details of the game processing according to the exemplary embodiment will be described. FIG. 9 to FIG. 13 show examples of flowcharts showing the details of the game processing according to the exemplary embodiment.

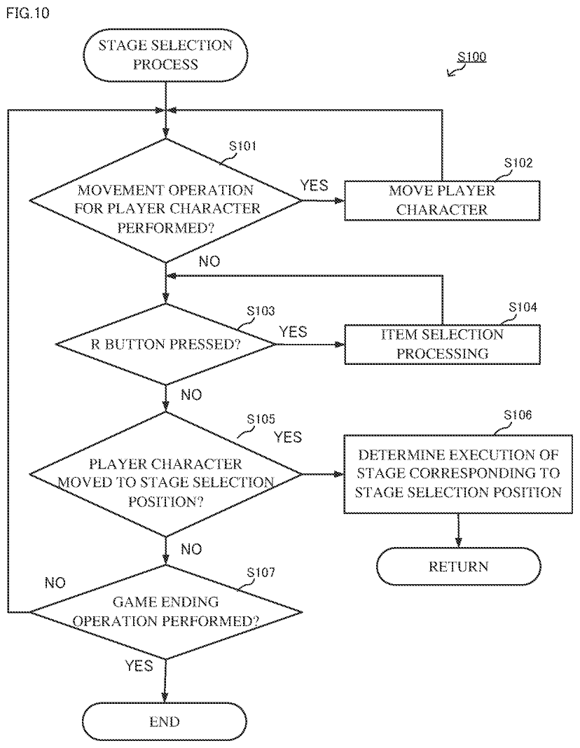

First, when this game processing is started, in step S100 in FIG. 9, the processor 81 performs a stage selection process described later with reference to FIG. 10. Then, the process proceeds to step S200.

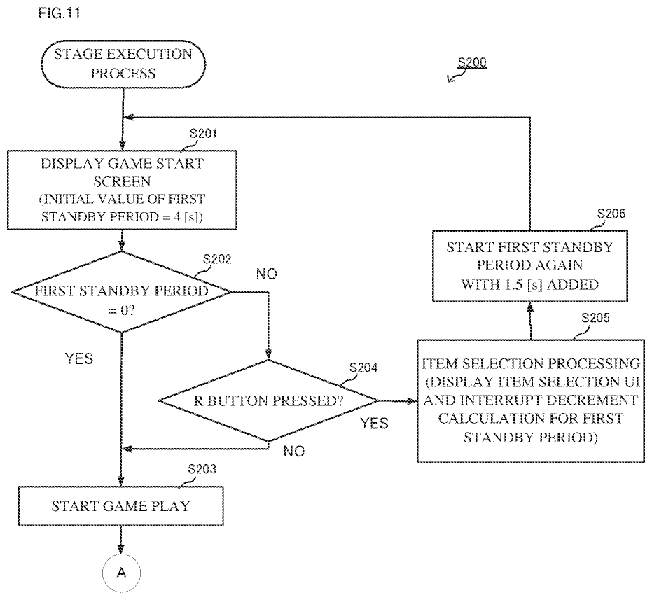

In step S200, the processor 81 performs a stage execution process described later with reference to FIG. 11 to FIG. 13. Then, the process returns to step S100. In step S107 described later with reference to FIG. 10, if a game ending operation is performed, this game processing is ended.

FIG. 10 shows an example of a flowchart showing the details of the stage selection process. This will be described below with reference to FIG. 10.

First, in step S101, the processor 81 determines whether or not an operation of moving the player character has been performed in a state in which the stage selection screen is displayed (see FIG. 4(1)), on the basis of the operation data 410. If the determination result is YES, the process proceeds to step S102, and if the determination result is NO, the process proceeds to step S103.

In step S102, the processor 81 moves the player character in the stage selection space on the basis of the operation in step S101. Then, the process returns to step S101. Through the processing in steps S101 and S102, the player character 200 moves on the stage selection screen in accordance with a player's operation (see FIG. 4(1)).

In step S103, the processor 81 determines whether or not the R button is pressed, on the basis of the operation data 410. If the determination result is YES, the process proceeds to step S104, and if the determination result is NO, the process proceeds to step S105.

In step S104, the processor 81 executes item selection processing. Specifically, as described with reference to FIG. 4(2), the item selection UI is displayed, and then, at the same time as an operation of selecting an item (replacement or the like) is finished, display of the item selection UI is ended. Then, the process returns to step S103.

In step S105, the processor 81 determines whether or not the player character has moved to any of stage selection positions in the stage selection space, on the basis of the object data 403 and the like. If the determination result is YES, the process proceeds to step S106, and if the determination result is NO, the process proceeds to step S107.

In step S106, the processor 81 determines execution of a stage corresponding to the stage selection position to which the player character has moved in step S105. That is, execution of the game stage selected by the player operating the player character is determined. Then, the process proceeds to step S200 in FIG. 9, so that a game in the stage selected by the player in step S106 is started.

In step S107, the processor 81 determines whether or not a predetermined game ending operation has been performed, on the basis of the operation data 410. If the determination result is YES, this game processing is ended, and if the determination result is NO, the process returns to step S101.

FIG. 11 to FIG. 13 show examples of flowcharts showing the details of the stage execution process. This will be described below with reference to FIG. 11 to FIG. 13.

First, in step S201 in FIG. 11, the processor 81 starts display of the game start screen of the stage determined in step S106 in FIG. 10, using the image data 408, and at the same time, starts the first standby period set at four seconds (initial value) (see FIG. 5(1)). In addition, during the first standby period, the processor 81 loads data regarding the stage from a server via the Internet, or from a storage medium mounted to the slot 23, etc. Then, the process proceeds to step S202.

In step S202, the processor 81 determines whether or not the first standby period set in step S201 has become zero (the first standby period has ended). If the determination result is YES, the process proceeds to step S203, and if the determination result is NO, the process proceeds to step S204.

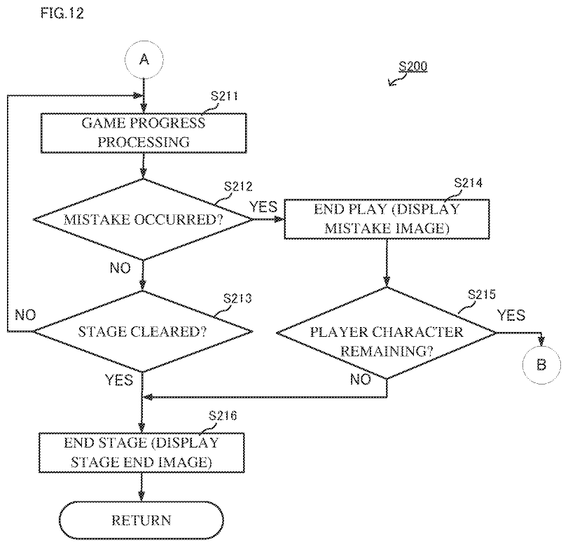

In step S203, the processor 81 starts game play in the stage determined in step S106 in FIG. 10 (see FIG. 5(3)). Then, the process proceeds to step S211 in FIG. 12.

In step S204, the processor 81 determines whether or not the R button is pressed, on the basis of the operation data 410. If the determination result is YES, the process proceeds to step S205, and if the determination result is NO, the process proceeds to step S203.

In step S205, the processor 81 executes item selection processing. Specifically, as described with reference to FIG. 5(2), the processor 81 displays the item selection UI, and at the same time, interrupts the first standby period (interrupts time decrement calculation). Then, when an operation of selecting an item is finished, the process proceeds to step S206.

In step S206, the processor 81 starts again the first standby period interrupted in step S205, with 1.5 seconds added thereto (the first standby period prolonged). Then, the process returns to step S201, to start display of the game start screen again.

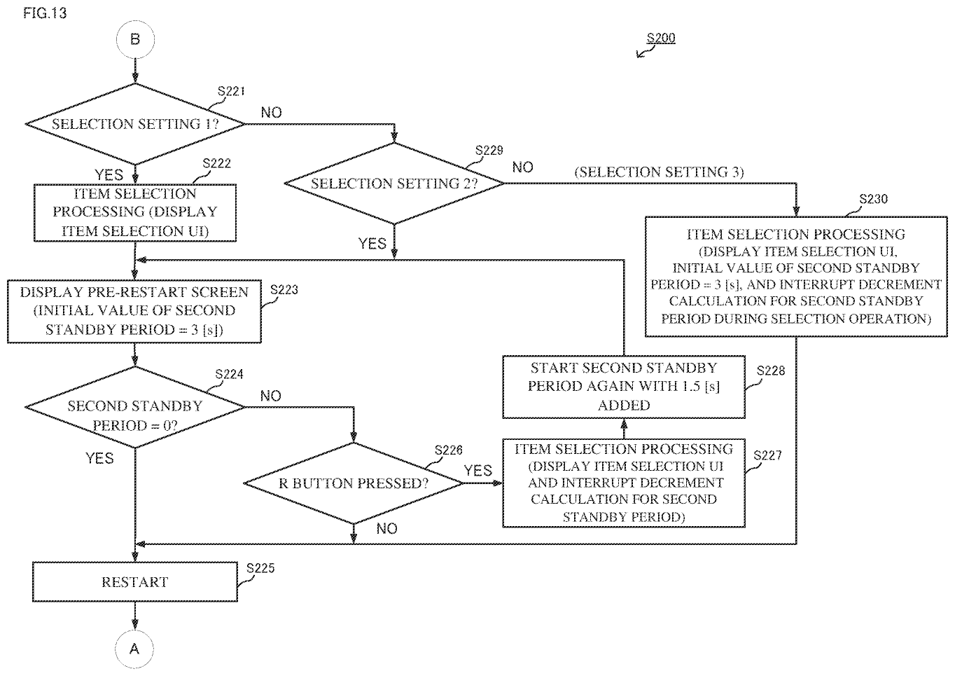

Next, in step S211 in FIG. 12, the processor 81 performs game progress processing in the game play started in step S203 in FIG. 11 (or the game play restarted in step S225 in FIG. 13). Specifically, the processor 81 causes the game to progress by performing movement of the player character 200 and the like on the basis of the operation data 410 and the like. During game progress (during game play), selection of an item (replacement or the like) cannot be performed. Then, the process proceeds to step S212.

In step S212, the processor 81 determines whether or not the player character has made a mistake such as contacting with an enemy character (see FIG. 6(1)). If the determination result is YES, the process proceeds to step S214, and if the determination result is NO, the process proceeds to step S213.

In step S213, the processor 81 determines whether or not the stage has been cleared. If the determination result is YES, the process proceeds to step S216, and if the determination result is NO, the process returns to step S211, to continue game progress.

In step S214, the processor 81 displays a mistake image and ends the play (see FIG. 6(1)). Then, the process proceeds to S215.

In step S215, the processor 81 determines whether or not there is a player character remaining. If the determination result is YES, the process proceeds to step S221 in FIG. 13, and if the determination result is NO, the process proceeds to step S216.

In step S216, the processor 81 displays a stage end image (not shown) and ends the stage. Then, the process returns to S100 in FIG. 9.

Next, in step S221 in FIG. 13, the processor 81 determines whether or not the current setting is the selection setting 1. As described with reference to FIG. 6, the selection setting is a setting regarding control of item selection in a scene for restarting a game, and is set by the player in advance. If the determination result is YES, the process proceeds to step S222, and if the determination result is NO, the process proceeds to step S229.

In step S222, the processor 81 performs item selection processing. Specifically, as described with reference to FIG. 6(2), the processor 81 automatically displays the item selection UI, and when an operation of selecting an item is finished, the process proceeds to step S223.

In step S223, the processor 81 displays the pre-restart screen. Specifically, as described with reference to FIG. 7(1), the processor 81 displays the pre-restart screen, and at the same time, starts the second standby period set at three seconds (initial value). Then, the process proceeds to step S224.

In step S224, the processor 81 determines whether or not the second standby period set in step S223 has become zero (the second standby period has ended). If the determination result is YES, the process proceeds to step S225, and if the determination result is NO, the process proceeds to step S226.

In step S225, the processor 81 restarts game play from the position where it is determined that the mistake has occurred in step S212 in FIG. 12 (the mistake position in the stage) (see FIG. 7(3)). In addition, the processor 81 decrements the number of remaining player characters by 1. Then, the process returns to step S211 in FIG. 12.

In step S226, the processor 81 determines whether or not the R button is pressed. If the determination result is YES, the process proceeds to step S227, and if the determination result is NO, the process proceeds to step S225.

In step S227, the processor 81 executes item selection processing. Specifically, as described with reference to in FIG. 7(2), the processor 81 displays the item selection UI, and at the same time, interrupts the second standby period (interrupts time decrement calculation). Then, when an operation of selecting an item is finished, the process proceeds to step S228.

In step S228, the processor 81 starts again the second standby period interrupted in step S227, with 1.5 seconds added thereto (the second standby period prolonged). Then, the process returns to step S223, to start display of the pre-restart screen again.

In step S229, the processor 81 determines whether or not the current setting is the selection setting 2. If the determination result is YES, the process proceeds to step S223, and if the determination result is NO, the current setting is the selection setting 3 and therefore the process proceeds to step S230.

In step S230, the processor 81 executes item selection processing. Specifically, as described with reference to FIG. 6(3), the processor 81 automatically displays the item selection UI, and at the same time, starts the second standby period set at three seconds (initial value). The second standby period is interrupted (the time decrement calculation is interrupted) during a period in which an operation of selecting an item is performed on the item selection UI. Then, as described with reference to FIG. 6(3), at the same time as the second standby period ends, the processor 81 ends display of the item selection UI. Then, the process proceeds to step S225.

As described above, according to the exemplary embodiment, by performing a button operation on the stage selection screen before start of game play, the item selection UI is displayed, whereby item selection can be performed (see FIG. 4), and thereafter, also at the time of starting game play in the selected stage, the item selection UI is displayed by performing a button operation, whereby item selection can be performed (see FIG. 5). Thus, even if the player forgets to perform item selection before starting game play, an item can be selected at the time of starting game play. Further, in a case of not performing item selection, a game can be smoothly started without increasing the waiting time.

In addition, according to the exemplary embodiment, in a case of restarting a game after making a mistake, item selection (item replacement or the like) can be performed by a button operation during display of the pre-restart screen, and on the other hand, if a button operation is not performed, after elapse of a predetermined period, display of the pre-restart screen is ended and a game is restarted (see “selection setting 2” in FIG. 6 and FIG. 7). Thus, item selection can be performed at the time of restarting a game, and in a case of not performing item selection, a game can be smoothly restarted without increasing the waiting time.

In addition, according to the exemplary embodiment, in a case of restarting a game after making a mistake, the item selection UI can be automatically displayed, whereby item selection (item replacement or the like) can be performed, and thereafter, during display of the pre-restart screen, the item selection UI is displayed by a button operation, whereby item selection (item replacement or the like) can be performed, and on the other hand, if a button operation is not performed, after elapse of a predetermined period, display of the pre-restart screen is ended and a game is restarted (see “selection setting 1” in FIG. 6 and FIG. 7). Thus, at the time of restarting a game, the player can be prevented from forgetting to perform item selection (item replacement or the like), and thereafter, the player can revise item selection by a button operation.

In addition, according to the exemplary embodiment, in a case of restarting a game after making a mistake, the item selection UI can be automatically displayed, whereby item selection (item replacement or the like) can be performed, and during an item selection operation, the standby period is interrupted until the item selection UI is ended and a game is restarted (see “selection setting 3” in FIG. 6 and FIG. 7). Thus, the player can be prevented from forgetting to perform item selection (item replacement or the like) at the time of restarting a game, and a game can be prevented from restarting during an item selection operation.

### Modifications

In the above exemplary embodiment, a configuration example in which the player selects a desired stage has been shown (see FIG. 4). However, for example, the order of stages may be determined in advance and the stages may be cleared in that order.

In the above exemplary embodiment, the player may be allowed to select, in advance, at least two of the selection settings 1 to 3 (see FIG. 6) for restarting.

In the above exemplary embodiment, the item selection UI may not necessarily have the same design (see FIG. 4 to FIG. 7).

In the above exemplary embodiment, the case where the sequential processing in the game processing is executed by a single game apparatus has been described. In another exemplary embodiment, the sequential processing may be executed in an information processing system including a plurality of information processing apparatuses. For example, in an information processing system including a terminal-side apparatus and a server-side apparatus that can communicate with the terminal-side apparatus via a network, a part of the sequential processing may be executed by the server-side apparatus. In an information processing system including a terminal-side apparatus and a server-side apparatus that can communicate with the terminal-side apparatus via a network, a major part of the sequential processing may be executed by the server-side apparatus and a part of the sequential processing may be executed by the terminal-side apparatus. In the information processing system, a server-side system may include a plurality of information processing apparatuses and processing to be executed on the server side may be executed by the plurality of information processing apparatuses in a shared manner. A configuration of so-called cloud gaming may be adopted. For example, the game apparatus may transmit operation data indicating a user's operation to a predetermined server, various game processing may be executed on the server, and the execution result may be distributed as a video and a sound by streaming to the game apparatus.

While the exemplary embodiments and modifications have been described above, it is to be understood that the above description is, in all aspects, merely an illustrative example, and is not intended to limit the scope thereof. In addition, it is to be understood that various improvements and changes can be made on the exemplary embodiments and modifications.

What is claimed is:

1. A non-transitory computer-readable storage medium having stored therein instructions that, when executed by a processor of a game processing apparatus for controlling a player character on the basis of an operation input in a stage set in a virtual space, cause the game processing apparatus to:
allow at least one of a plurality of kinds of items to be set on the player character;
determine a stage to be played, from among a plurality of the stages;
start a first standby period from the determination of the stage to start of the stage;
when a predetermined operation input is performed during the first standby period, interrupt the first standby period and present an item selection UI for selecting the item and setting the item on the player character;
in a case where the item selection UI is presented, start the first standby period again after selection of the item is finished;
after elapse of the first standby period, start game play in the stage; and
in game play in the stage, control the player character on the basis of an operation input, while imparting a predetermined effect corresponding to the kind of the set item, to a behavior of the player character or another object in the stage.

2. The storage medium according to claim 1, the instructions further causing the game processing apparatus to:
in a case where the player character satisfies a predetermined condition as a mistake in the stage, end play and start a second standby period until restart of play;
when a predetermined operation input is performed during the second standby period, interrupt the second standby period and present an item selection UI for selecting the item and setting the item on the player character;
in a case where the item selection UI is presented, start the second standby period again after selection of the item is finished; and
after elapse of the second standby period, restart play from a predetermined position in the stage.

3. The storage medium according to claim 1, the instructions further causing the game processing apparatus to:
in a case where the player character satisfies a predetermined condition as a mistake in the stage, end play and start a second standby period until restart of play;
present an item selection UI for selecting the item and setting the item on the player character;
when a predetermined operation input for selecting the item is performed during the second standby period, interrupt the second standby period, and after selection of the item is finished, start the second standby period again; and
after elapse of the second standby period, restart play from a predetermined position in the stage.

4. The storage medium according to claim 1, the instructions further causing the game processing apparatus to:
in a case where the player character has satisfied a predetermined condition as a mistake in the stage, end play and present an item selection UI for selecting the item and setting the item on the player character;
after selection of the item is finished, start a second standby period until restart of play;
when a predetermined operation input is performed during the second standby period, interrupt the second standby period and present the item selection UI, and after selection of the item is finished, start the second standby period again; and
after elapse of the second standby period, restart play from a predetermined position in the stage.

5. The storage medium according to claim 1, the instructions causing the game processing apparatus to:
in a scene before the stage to be played is determined, present the item selection UI on the basis of an operation input, to allow selection of the item to be set.

6. The storage medium according to claim 1, the instructions causing the game processing apparatus to:
in game play in the stage, control the player character without allowing change of the item set on the player character.

7. The storage medium according to claim 1, the instructions causing the game processing apparatus to:
in a case where the item selection UI is presented during the first standby period, start the first standby period again with a remaining time thereof prolonged by a predetermined period, after selection of the item is finished.

8. The storage medium according to claim 1, the instructions causing the game processing apparatus to:
load data regarding the stage during the first standby period.

9. A game processing system for controlling a player character on the basis of an operation input in a stage set in a virtual space, the game processing system comprising a processor and a memory coupled thereto, the processor being configured to control the game processing system to at least:
allow at least one of a plurality of kinds of items to be set on the player character;
determine a stage to be played, from among a plurality of the stages;
start a first standby period from the determination of the stage to start of the stage;
when a predetermined operation input is performed during the first standby period, interrupt the first standby period and present an item selection UI for selecting the item and setting the item on the player character;
in a case where the item selection UI is presented, start the first standby period again after selection of the item is finished;
after elapse of the first standby period, start game play in the stage; and
in game play in the stage, control the player character on the basis of an operation input, while imparting a predetermined effect corresponding to the kind of the set item, to a behavior of the player character or another object in the stage.

10. The game processing system according to claim 9, the processor being configured to further control the game processing system to:
in a case where the player character satisfies a predetermined condition as a mistake in the stage, end play and start a second standby period until restart of play;
when a predetermined operation input is performed during the second standby period, interrupt the second standby period and present an item selection UI for selecting the item and setting the item on the player character;
in a case where the item selection UI is presented, start the second standby period again after selection of the item is finished; and
after elapse of the second standby period, restart play from a predetermined position in the stage.

11. The game processing system according to claim 9, the processor being configured to further control the game processing system to:
in a case where the player character satisfies a predetermined condition as a mistake in the stage, end play and start a second standby period until restart of play;
present an item selection UI for selecting the item and setting the item on the player character;
when a predetermined operation input for selecting the item is performed during the second standby period, interrupt the second standby period, and after selection of the item is finished, start the second standby period again; and
after elapse of the second standby period, restart play from a predetermined position in the stage.

12. The game processing system according to claim 9, the processor being configured to further control the game processing system to:
in a case where the player character has satisfied a predetermined condition as a mistake in the stage, end play and present an item selection UI for selecting the item and setting the item on the player character;
after selection of the item is finished, start a second standby period until restart of play;
when a predetermined operation input is performed during the second standby period, interrupt the second standby period and present the item selection UI, and after selection of the item is finished, start the second standby period again; and
after elapse of the second standby period, restart play from a predetermined position in the stage.

13. The game processing system according to claim 9, the processor being configured to control the game processing system to:
in a scene before the stage to be played is determined, present the item selection UI on the basis of an operation input, to allow selection of the item to be set.

14. The game processing system according to claim 9, the processor being configured to control the game processing system to:
in game play in the stage, control the player character without allowing change of the item set on the player character.

15. The game processing system according to claim 9, the processor being configured to control the game processing system to:
in a case where the item selection UI is presented during the first standby period, start the first standby period again with a remaining time thereof prolonged by a predetermined period, after selection of the item is finished.

16. The game processing system according to claim 9, the processor being configured to control the game processing system to:
load data regarding the stage during the first standby period.

17. A game processing apparatus for controlling a player character on the basis of an operation input in a stage set in a virtual space, the game processing apparatus comprising a processor and a memory coupled thereto, the processor being configured to control the game processing apparatus to at least:
allow at least one of a plurality of kinds of items to be set on the player character;
determine a stage to be played, from among a plurality of the stages;
start a first standby period from the determination of the stage to start of the stage;
when a predetermined operation input is performed during the first standby period, interrupt the first standby period and present an item selection UI for selecting the item and setting the item on the player character;
in a case where the item selection UI is presented, start the first standby period again after selection of the item is finished;
after elapse of the first standby period, start game play in the stage; and
in game play in the stage, control the player character on the basis of an operation input, while imparting a predetermined effect corresponding to the kind of the set item, to a behavior of the player character or another object in the stage.

18. A game processing method executed by a processor configured to control a game processing system for controlling a player character on the basis of an operation input in a stage set in a virtual space, the game processing method causing the game processing system to:
allow at least one of a plurality of kinds of items to be set on the player character;
determine a stage to be played, from among a plurality of the stages;
start a first standby period from the determination of the stage to start of the stage;
when a predetermined operation input is performed during the first standby period, interrupt the first standby period and present an item selection UI for selecting the item and setting the item on the player character;
in a case where the item selection UI is presented, start the first standby period again after selection of the item is finished;
after elapse of the first standby period, start game play in the stage; and
in game play in the stage, control the player character on the basis of an operation input, while imparting a predetermined effect corresponding to the kind of the set item, to a behavior of the player character or another object in the stage.
